(19) United States
(12) Patent Application Publication
(10) Pub. No.: US 2023/0217404 A1
(43) Pub. Date: Jul. 6, 2023

(54) POSITIONING AND RANGING METHOD AND TERMINAL DEVICE, COMMUNICATION DEVICE AND STORAGE MEDIUM

(71) Applicant: BEIJING XIAOMI MOBILE SOFTWARE CO., LTD., Beijing (CN)

(72) Inventor: Yang LIU, Beijing (CN)

(73) Assignee: BEIJING XIAOMI MOBILE SOFTWARE CO., LTD., Beijing (CN)

(21) Appl. No.: 18/008,964

(22) PCT Filed: Jun. 11, 2020
(86) PCT No.: PCT/CN2020/095684

§ 371 Date: Dec. 7, 2022

(51) Int. Cl. H04W 64/00; H04W 76/10; H04L 5/00

(52) U.S. Cl. CPC H04W 64/00; H04W 76/10; H04L 5/0048; H04W 92/18

(57) ABSTRACT

A positioning and ranging method, and including: sending a configuration of a frame structure to a terminal device, the frame structure including a first time unit, the first time unit being used for positioning and/or ranging, and a working frequency of the frame structure being in a frequency band not less than 6 GHz.

### CROSS REFERENCE TO RELATED APPLICATION

The present application is a U.S. National Stage of International Application No. PCT/CN2020/095684, filed on Jun. 11, 2020, the entire content of which is incorporated herein by reference for all purposes.

### BACKGROUND

In order to determine a distance between itself and other terminal devices, the terminal device usually needs ranging.

### SUMMARY

Examples of the disclosure provide a positioning and ranging method, a terminal device, a communication device and a storage medium.

According to an aspect of the disclosure, a positioning and ranging method is provided, including:

sending a configuration of a frame structure to a terminal device, the frame structure including a first time unit, and the first time unit being configured for positioning or ranging; where

a working frequency of the frame structure belongs to a frequency band not less than 6 GHz.

According to an aspect of the disclosure, a positioning and ranging method is provided, including:

obtaining a configuration of a frame structure, the frame structure including a first time unit, and the first time unit being configured for positioning or ranging; and

performing positioning or ranging on the first time unit, where

a working frequency of the frame structure belongs to a frequency band not less than 6 GHz.

According to an aspect of the disclosure, a terminal device is provided, including: a processor; a transceiver connected with the processor; and a memory for storing an executable instruction of the processor, where the processor is configured to load and execute the executable instruction so as to implement the positioning and ranging method as described in the above aspects.

### BRIEF DESCRIPTION OF THE DRAWINGS

In order to illustrate technical solutions in examples of the disclosure more clearly, drawings needing to be used in description of the examples will be introduced below briefly. Apparently, the drawings in the following description are merely some examples of the disclosure, those skilled in the art can further obtain other drawings according to these drawings without inventive efforts.

FIG. 1 is a block diagram of a communication system provided by an example of the disclosure.

FIG. 2 is a flow diagram of a positioning and ranging method provided by an example of the disclosure.

FIG. 3 is a schematic diagram of a frame structure provided by an example of the disclosure.

FIG. 4 is a schematic diagram of a frame structure provided by an example of the disclosure.

FIG. 5 is a schematic diagram of locations of a terahertz frequency band and a millimeter wave frequency band in an electromagnetic wave spectrum provided by an example of the disclosure.

FIG. 6 is a flow diagram of a positioning and ranging method provided by an example of the disclosure.

FIG. 7 is a flow diagram of a positioning and ranging method provided by an example of the disclosure.

FIG. 8 is a flow diagram of a positioning and ranging method provided by an example of the disclosure.

FIG. 9 is a block diagram of a positioning and ranging apparatus provided by an example of the disclosure.

FIG. 10 is a block diagram of a positioning and ranging apparatus provided by an example of the disclosure.

FIG. 11 is a block diagram of a communication device provided by an example of the disclosure.

### DETAILED DESCRIPTION

Reference will now be described in detail to examples, which are illustrated in the accompanying drawings. The following description refers to the accompanying drawings in which the same numbers in different drawings represent the same or similar elements unless otherwise represented. The examples described following do not represent all examples consistent with the present disclosure. Instead, they are merely examples of devices and methods consistent with aspects of the disclosure as detailed in the appended claims.

Terms used in the present disclosure are merely for describing specific examples and are not intended to limit the present disclosure. The singular forms “one”, “the”, and “this” used in the present disclosure and the appended claims are also intended to include a multiple form, unless other meanings are clearly represented in the context. It should also be understood that the term “and/or” used in the present disclosure refers to any or all of possible combinations including one or more associated listed items.

Reference throughout this specification to “one embodiment,” “an embodiment,” “an example,” “some embodiments,” “some examples,” or similar language means that a particular feature, structure, or characteristic described is included in at least one embodiment or example. Features, structures, elements, or characteristics described in connection with one or some embodiments are also applicable to other embodiments, unless expressly specified otherwise.

It should be understood that although terms “first”, “second”, “third”, and the like are used in the present disclosure to describe various information, the information is not limited to the terms. These terms are merely used to differentiate information of a same type. For example, without departing from the scope of the present disclosure, first information is also referred to as second information, and similarly the second information is also referred to as the first information. Depending on the context, for example, the term “if” used herein may be explained as “when” or “while”, or “in response to . . . , it is determined that”.

The terms “module,” “sub-module,” “circuit,” “sub-circuit,” “circuitry,” “sub-circuitry,” “unit,” or “sub-unit” may include memory (shared, dedicated, or group) that stores code or instructions that can be executed by one or more processors. A module may include one or more circuits with or without stored code or instructions. The module or circuit may include one or more components that are directly or indirectly connected. These components may or may not be physically attached to, or located adjacent to, one another.

A unit or module may be implemented purely by software, purely by hardware, or by a combination of hardware and software. In a pure software implementation, for example, the unit or module may include functionally related code blocks or software components, that are directly or indirectly linked together, so as to perform a particular function.

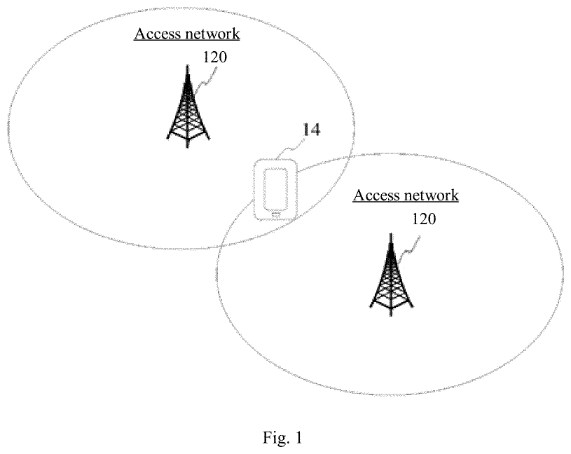

FIG. 1 shows a block diagram of a communication system provided by an example of the disclosure. The communication system may include: an access network 12 and a terminal device 14.

The access network 12 includes a plurality of network devices 120. The network device 120 may be a base station, and the base station is an apparatus deployed in the access network to provide a wireless communication function for the terminal device. The base station may include various forms of macro base stations, micro base stations, relay stations, access points and the like. In systems adopting different wireless access technologies, names of devices with base station functions may be different. For example, in an LTE system, the device is called eNodeB or eNB; and in a 5G NR system, the device is called gNodeB or gNB. With evolution of a communication technology, the description of the “base station” may change. To facilitate the description in the examples of the disclosure, the above apparatuses that provide the wireless communication function for the terminal device 14 are collectively referred to as the network device.

The terminal device 14 may include various handheld devices, vehicle-mounted devices, wearable devices and computing devices with the wireless communication functions, or other processing devices connected to a wireless modem, as well as various forms of user equipment, mobile stations (MS), terminal devices and the like. For the convenience of description, the devices mentioned above are collectively referred to as the terminal device. The network device 120 and the terminal device 14 communicate with each other through a certain air interface technology, such as a Uu interface.

In some examples, the terminal device 14 supports sidelink. Sidelink is a device-to-device communication mode with a high spectrum efficiency and a low transmission delay.

The technical solutions of the examples of the disclosure may be applied to various communication systems, such as a global system of mobile communication (GSM), a code division multiple access (CDMA) system, a wideband code division multiple access (WCDMA) system, a general packet radio service (GPRS), a long term evolution (LTE) system, an LTE frequency division duplex (FDD) system, an LTE time division duplex (TDD) system, an advanced long term evolution (LTE-A) system, a new radio (NR) system, an evolution system of the NR system, an LTE-based access to unlicensed spectrum (LTE-U) system, an NR-U system, a universal mobile telecommunication system (UMTS), a worldwide interoperability for microwave access (WiMAX) communication system, wireless local area networks (WLAN), wireless fidelity (WiFi), a next-generation communication system or other communication systems.

Generally speaking, the connection number supported by a traditional communication system is limited and is easy to implement. However, with the development of the communication technology, the mobile communication system will not merely support traditional communication, but also support, for example, device to device (D2D) communication, machine to machine (M2M) communication, machine type communication (MTC), vehicle to vehicle (V2V) communication, vehicle to everything (V2X) system and the like. The examples of the disclosure may also be applied to these communication systems.

In order to determine a distance between itself and other terminal devices, the terminal device usually needs ranging.

In the related art, no support has been provided for a ranging demand of the terminal device.

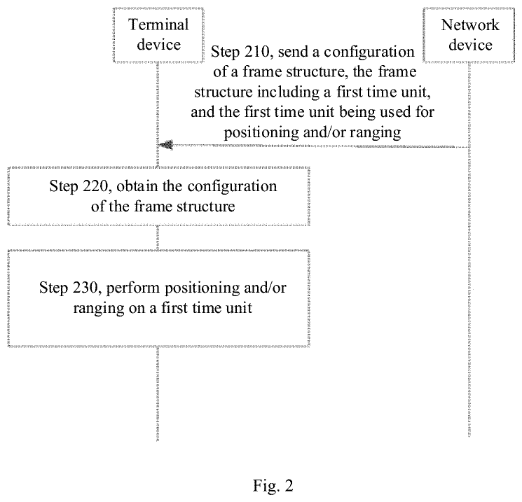

FIG. 2 shows a flow diagram of a positioning and ranging method provided by an example of the disclosure, applied to the terminal device and the network device as shown in FIG. 1. The method includes:

in step 210, the network device sends a configuration of a frame structure to the terminal device, the frame structure includes a first time unit, and the first time unit is used for positioning and/or ranging.

A working frequency of the frame structure belongs to a frequency band not less than 6 GHz. One frequency band refers to a frequency range of uplink and downlink. The working frequency of the frame structure is a frequency band greater than (or not less than) 6 GHz. At present, it is difficult to obtain a wide consecutive spectrum in the frequency band below 6 GHz. In a case that the working frequency of the frame structure belongs to the frequency band not less than 6 GHz, spectrum resources are relatively rich. In some examples, the frequency band to which the working frequency of the frame structure belongs may also be a frequency band not less than M GHz, and M is a value other than 6, which is not limited in the example of the disclosure.

The frame structure refers to a structure of a frame composed of several parts that perform different functions. The first time unit used for positioning and/or ranging refers to: the first time unit in the frame structure is provided to the terminal device for ranging; or, provided to the terminal device for ranging or positioning. That is, the first time unit is used for ranging, and may also be used for positioning when the terminal device needs positioning.

In a possible implementation, the first time unit is dedicated to positioning and/or ranging and is not used to perform other functions. In another possible implementation, the first time unit may further be used for performing other functions. In a case that the terminal device does not need to perform positioning and/or ranging, the terminal device uses a time-frequency resource on the first time unit to perform other functions. But in a case that the terminal device needs to perform positioning and/or ranging, the terminal device uses the time-frequency resource on the first time unit to perform positioning and/or ranging preferentially.

In a possible implementation, in the case that the terminal device needs to perform positioning or ranging, the terminal device requests the network device for the above frame structure including the first time unit, and the network device sends the configuration of the frame structure to the terminal device in response to the request of the terminal device. In another possible implementation, the network device dynamically sends the configuration of the frame structure to the terminal device.

In some examples, the network device sends the configuration of the frame structure to other terminal devices except the terminal device. A sidelink is established between the terminal device and other terminal devices.

The network device broadcasts the sending of the configuration of the frame structure to the terminal device in a plurality of cells, so that the plurality of terminal devices use the frame structure with the same configuration for wireless communication transmission. Since sidelink is established between the terminal devices, device-to-device communication may be performed directly, so that the terminal device performs ranging on the first time unit to measure a distance between the two terminal devices.

In step 220, the terminal device obtains the configuration of the frame structure.

The terminal device obtains the configuration of the frame structure from the network device and performs wireless communication transmission according to the configuration of the frame structure.

In another implementation, the configuration of the frame structure is agreed in a protocol, and the terminal device does not need to obtain it from the network device. The terminal device merely needs to perform wireless communication transmission according to the frame structure agreed in the protocol, and perform positioning and/or ranging on the first time unit in the frame structure.

In step 230, the terminal device performs positioning and/or ranging on the first time unit.

In the case that the terminal device needs to perform positioning or ranging, the terminal device performs positioning or ranging on the specified first time unit.

In some examples, positioning refers to that the terminal device obtains its own geographic location information, and ranging refers to that the terminal device obtains distance information between itself and other geographic locations, or the terminal device obtains distance information between itself and other terminal devices.

The example of the disclosure does not limit the positioning and ranging method adopted by the terminal device on the first time unit. For example, on the first time unit, by sending and receiving ultra-narrow pulses with nanosecond or microsecond level or below, and by detecting a location of a signal pulse in combination with some positioning algorithms, time of a signal flying in the air is calculated. The time is multiplied by a rate (generally considered as speed of light) of signal transmission in the air to obtain a distance between a detection device and a detected device. In conclusion, according to the method provided by the present example, the network device may configure the terminal device with the frame structure including the first time unit, and the working frequency of the frame structure belongs to the frequency band not less than 6 GHz. As the first time unit is used for positioning and/or ranging, the terminal device can use the time-frequency resource on the first time unit to perform positioning and/or ranging, avoiding the situation where no time-frequency resource is available to perform positioning and/or ranging, and ensuring normal operating of the positioning and ranging service.

In an example based on FIG. 2, a case of the first time unit in a time domain is illustrated first in an example manner.

In an example, the first time unit occupies t consecutive time units in the time domain, and t is a positive integer.

When configuring the frame structure, the network device may select a consecutive length of the first time unit in the time domain. In a possible implementation, a duration of the first time unit corresponds to a set, such as {a, 2*a, 3*a, 4*a, 5*a}, and the network device selects one from the above set as the consecutive duration of the first time unit in the time domain. In another possible implementation, the t consecutive time units of the first time unit in the time domain are specified in the protocol.

In some examples, the time unit of the first time unit includes, but is not limited to: at least one of a subframe, a time slot or a symbol.

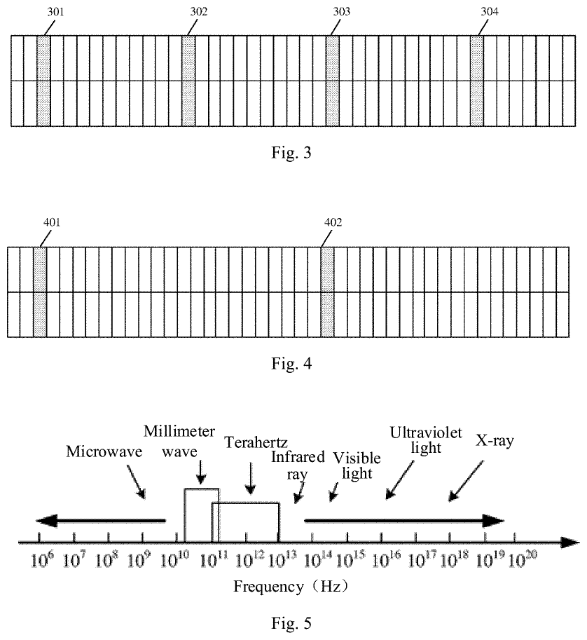

In the example of the disclosure, an example that the time unit of the first time unit is the time slot is taken for illustration, for example, the first time unit is called a positioning slot. With reference to FIG. 3, the first time unit has one consecutive time unit (i.e. one time slot) in the time domain. The first time unit includes: a time slot 301, a time slot 302, a time slot 303 and a time slot 304.

The subframe is divided by an NR standard transmission 10 millisecond frame. Each subframe has a time length of 1 millisecond and is further divided into several time slots. The time slot is a basic unit of scheduling, which is composed of a fixed number of orthogonal frequency division multiplexing (OFDM) symbols.

In some examples, the time length of the time slot is 1 millisecond. At this time, a subcarrier interval is 15 kHz.

In some examples, the time length of the time slot is 0.5 millisecond. At this time, a subcarrier interval is 30 kHz.

In some examples, the time length of the time slot is 0.25 millisecond. At this time, a subcarrier interval is 60 kHz.

In some examples, the time length of the time slot is 0.125 millisecond. At this time, a subcarrier interval is 120 kHz.

In some examples, the time length of the time slot is 0.0625 millisecond. At this time, a subcarrier interval is 240 kHz.

In an example, the first time unit occurs within the frame structure according to a period.

In a radio frame, the first time unit occurs in a certain period, and the network device may configure the period of the first time unit in the frame structure. In some examples, the occurrence period of the first time unit corresponds to a set, such as {n, 2*n, 3*n, 4*n, 5*n}, and the network device selects one from the above set as the occurrence period of the first time unit.

For example, referring to FIG. 4, the first time unit has one consecutive time unit (i.e. one time slot) in the time domain, and the first time unit includes: a time slot 401 and a time slot 402. If the period of the first time unit in FIG. 3 is n, the period of the first time unit in FIG. 4 is 2*n.

In one possible design, the period is related to a service load situation corresponding to the working frequency of the frame structure. The network device determines the occurrence period of the first time unit according to the service load situation corresponding to the working frequency of the configured frame structure. For example, the working frequency of the frame structure is a GHz to b GHz; in a case that a current service load of a GHz to b GHz is heavy (that is, the service is busy), the period is large; and in a case that the current service load of a GHz to b GHz is small (that is, the service is idle), the period is small, so as to ensure normal operating of other services.

For example, the first time unit corresponds to the two periods as shown in FIG. 3 and FIG. 4. When the service is busy, the network device selects the period shown in FIG. 4 for the terminal device. When the service is idle, the network device selects the period shown in FIG. 3 for the terminal device.

In conclusion, according to the method provided in the present example, the network device may flexibly configure the situation of the first time unit in the time domain to adapt to different scenarios and demands.

The situation of the first time unit in a frequency domain is illustrated below in an example manner.

In an example, the first time unit occupies m consecutive frequency units in the frequency domain, and m is a positive integer.

When configuring the frame structure, the network device may select a consecutive range of the first time unit in the frequency domain. In a possible implementation, a frequency domain range of the first time unit corresponds to a set, such as {f, 2*f, 3*f, 4*f, 5*f}, and the network device selects one from the above set as the consecutive range of the first time unit in the frequency domain. In another possible implementation, the m consecutive frequency units of the first time unit in the frequency domain are specified in the protocol.

In a possible design, a bandwidth corresponding to the first time unit is positively correlated with a frequency of the first time unit. That is, the higher the frequency of the first time unit is, the greater the bandwidth corresponding to the first time unit is; and the lower the frequency of the first time unit is, the smaller the bandwidth corresponding to the first time unit is.

In a possible design, in order to avoid occupying too much transmission bandwidth, the bandwidth corresponding to the first time unit has a maximum threshold, such as 500 megabytes. The bandwidth corresponding to the first time unit is not greater than 500 megabytes. In some examples, the working frequency of the frame structure belongs to at least one of a terahertz frequency band and a millimeter wave frequency band. For example, the working frequency of the frame structure belongs to the terahertz frequency band and the millimeter wave frequency band; or, the working frequency of the frame structure merely belongs to the terahertz frequency band; and the working frequency of the frame structure merely belongs to the millimeter wave frequency band.

The terahertz frequency band includes a frequency band between 300 GHz and 1000 GHz, and the millimeter wave frequency band includes a frequency band between 26.5 GHz and 300 GHz.

The terahertz frequency band is a frequency band between the millimeter wave frequency band and an optical frequency band. There are many spectrum resources not being fully developed. Traditionally, a microwave frequency band is defined as 300 MHz-26.5 GHz, the millimeter wave frequency band is 26.5 GHz-300 GHz, and the terahertz frequency band is 300 GHz-10000 GHz (i.e. 10 THz). In another definition, with reference to FIG. 5, 0.3 GHz-30 GHz is the microwave frequency band, 30 GHz-300 GHz is the millimeter wave frequency band, and 0.1 THz-10 THz is the terahertz frequency band.

It should be noted that the working frequency of the frame structure belongs to the terahertz frequency band, which may refer to all frequencies belonging to a range of the terahertz frequency band, or part of frequencies belonging to the range of the terahertz frequency band. Similarly, the working frequency of the frame structure belongs to the millimeter wave frequency band, which may refer to all frequencies belonging to a range of the millimeter wave frequency band, and may also refer to part of frequencies belonging to the range of the millimeter wave frequency band.

In conclusion, according to the method provided in the present example, the network device may flexibly configure the situation of the first time unit in the frequency domain to adapt to different scenarios and demands. Meanwhile, since there are abundant spectrum resources in the terahertz frequency band and the millimeter wave frequency band, the working frequency of the frame structure belongs to at least one of the terahertz frequency band and the millimeter wave frequency band, which is also suitable for the future development of the communication technology.

It should be noted that the configuration of the frame structure of the terminal device by the network device is illustrated in the above example in an example manner. In practice, the above frame structure may be configured to the terminal device in a manner of dynamic configuration, periodic configuration or semi-static configuration.

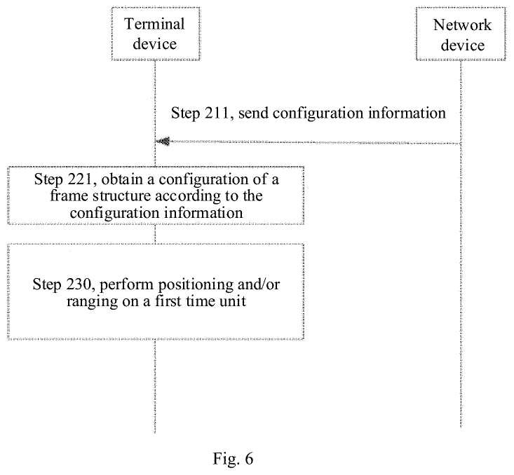

In the example based on FIG. 2, FIG. 6 shows a flow diagram of the positioning and ranging method provided by an example of the disclosure, applied to the terminal device and the network device as shown in FIG. 1. In the present example, a frame structure is dynamically configured to the terminal device. In the present example, step 210 is replaced by and implemented as step 211, and step 220 is replaced by and implemented as step 221.

In step 211: the network device sends configuration information to the terminal device.

In some examples, in a case that the network device judges that the frame structure of the terminal device needs to be adjusted, or in a case that the terminal device requests the network device to adjust the frame structure, the network device sends the configuration information to the terminal device to configure the frame structure.

In step 221: the terminal device obtains a configuration of the frame structure according to the configuration information.

After receiving the configuration information, the terminal device obtains the configuration of the frame structure from the configuration information. The frame structure includes a first time unit, and the first time unit is used for positioning and/or ranging.

In step 230: the terminal device performs positioning and/or ranging on the first time unit.

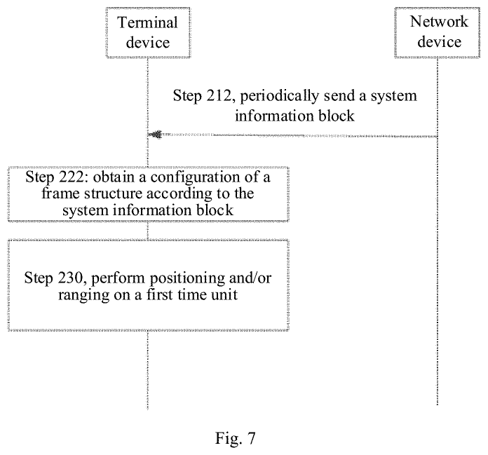

In the example based on FIG. 2, FIG. 7 shows a flow diagram of the positioning and ranging method provided by an example of the disclosure, applied to the terminal device and the network device as shown in FIG. 1. In the present example, a frame structure is periodically configured to the terminal device. In the present example, step 210 is replaced by and implemented as step 212, and step 220 is replaced by and implemented as step 222:

in step 212: the network device periodically sends a system information block to the terminal device.

The system information block (SIB) is an information block that carries system information. The system information is a general term for all public (not specific to the certain terminal device) information needed for normal operation of the terminal device in a network. The system information includes related information of the configuration of the frame structure.

In some examples, the system information block periodically sent by the network device to the terminal device is SIB1, that is, remaining minimum system information (RMSI). SIB1 contains the system information that the terminal needs to know before accessing the system.

In step 222: the terminal device obtains a configuration of the frame structure according to the system information block.

After receiving the system information block, the terminal device obtains the configuration of the frame structure from the system information block. The frame structure includes a first time unit, and the first time unit is used for positioning and/or ranging.

In step 230: the terminal device performs positioning and/or ranging on the first time unit.

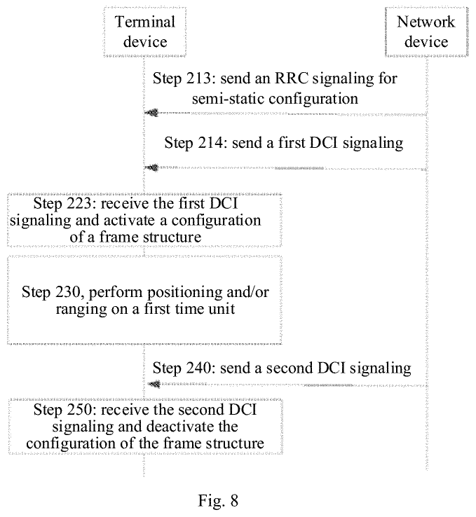

In the example based on FIG. 2, FIG. 8 shows a flow diagram of the positioning and ranging method provided by an example of the disclosure, applied to the terminal device and the network device as shown in FIG. 1. In the present example, a frame structure is semi-statically configured to the terminal device. In the present example, step 210 is replaced by and implemented as step 213 and step 214, and step 220 is replaced by and implemented as step 223:

in step 213: the network device sends an RRC signaling to the terminal device for semi-static configuration.

A radio resource control (RRC) signaling is a signaling for allocating radio resources. In some examples, the RRC signaling carries a configuration of the frame structure.

In some examples, after receiving the RRC signaling, the terminal device will not immediately start using the configured frame structure, but need the signaling to activate.

In step 214: the network device sends a first DCI signaling to the terminal device.

The frame structure configured semi-statically is activated by first downlink control information (DCI), and the first DCI signaling is carried on a physical downlink control channel (PDCCH).

In step 223: the terminal device receives the first DCI signaling and activates the configuration of the frame structure.

The activated frame structure includes a first time unit, and the first time unit is used for positioning and/or ranging.

In step 230: the terminal device performs positioning and/or ranging on the first time unit.

In step 240: the network device sends a second DCI signaling to the terminal device.

The second DCI signaling is another DCI signaling sent by the network device to the terminal device after the terminal device activates the configuration of the frame structure.

In some examples, the network device deactivates the configuration of the frame structure by sending another DCI signaling to the terminal device.

In step 250: the terminal device receives the second DCI signaling and deactivates the configuration of the frame structure.

In conclusion, the network device may configure the frame structure including the first time unit to the terminal device in the manner of dynamic configuration, periodic configuration or semi-static configuration, which improves the flexibility of configuration.

It should be noted that the above method examples can be implemented separately or in combination, which is not limited in the disclosure. In all the above examples, the steps executed by the terminal device may be independently implemented as the positioning and ranging method on one side of the terminal device, and the steps executed by the network device may be independently implemented as the positioning and ranging method on one side of the network device.

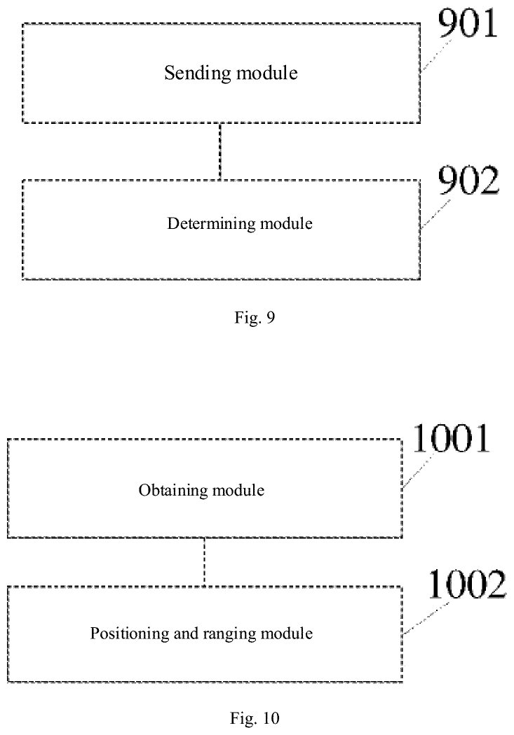

FIG. 9 shows a structural block diagram of a positioning and ranging apparatus provided by an example of the disclosure. The apparatus can be implemented as a network device, or as a part in the network device. The apparatus includes: a sending module 901.

The sending module 901 is configured to send a configuration of a frame structure to a terminal device, the frame structure includes a first time unit, and the first time unit is used for positioning and/or ranging.

A working frequency of the frame structure belongs to a frequency band not less than 6 GHz.

In an example, the first time unit occupies t consecutive time units in a time domain, and t is a positive integer.

In an example, the first time unit occupies m consecutive frequency units in a frequency domain, and m is a positive integer.

In an example, the first time unit occurs within the frame structure according to a period.

In an example, the apparatus further includes a determining module 902. The determining module 902 is configured to determine the period according to a service load situation corresponding to the working frequency of the frame structure.

In an example, the working frequency of the frame structure belongs to at least one of a terahertz frequency band and a millimeter wave frequency band. The terahertz frequency band includes a frequency band between 300 GHz and 1000 GHz, and the millimeter wave frequency band includes a frequency band between 26.5 GHz and 300 GHz.

In an example, the sending module 901 is configured to send the configuration of the frame structure to other terminal devices except the terminal device. A sidelink is established between the terminal device and other terminal devices.

In an example, a bandwidth corresponding to the first time unit is positively correlated with a frequency of the first time unit.

In an example, the bandwidth corresponding to the first time unit is not greater than 500 megabytes.

FIG. 10 shows a structural block diagram of a positioning and ranging apparatus provided by an example of the disclosure. The apparatus can be implemented as a terminal device, or as a part in the terminal device. The apparatus includes: an obtaining module 1001 and a positioning and ranging module 1002.

The obtaining module 1001 is configured to obtain a configuration of a frame structure, the frame structure includes a first time unit, and the first time unit is used for positioning and/or ranging; and

the positioning and ranging module 1002 is configured to perform positioning and/or ranging on the first time unit, where

a working frequency of the frame structure belongs to a frequency band not less than 6 GHz.

In an example, the first time unit occupies t consecutive time units in a time domain, and t is a positive integer.

In an example, the first time unit occupies m consecutive frequency units in a frequency domain, and m is a positive integer.

In an example, the first time unit occurs within the frame structure according to a period.

In an example, the period is related to a service load situation corresponding to the working frequency of the frame structure.

In an example, the working frequency of the frame structure belongs to at least one of a terahertz frequency band and a millimeter wave frequency band. The terahertz frequency band includes a frequency band between 300 GHz and 1000 GHz, and the millimeter wave frequency band includes a frequency band between 26.5 GHz and 300 GHz.

In an example, a bandwidth corresponding to the first time unit is positively correlated with a frequency of the first time unit.

In an example, the bandwidth corresponding to the first time unit is not greater than 500 megabytes.

In an example, the obtaining module 1001 is configured to receive configuration information from the network device; and the obtaining module 1001 is configured to obtain the configuration of the frame structure according to the configuration information.

In an example, the frame structure is periodically configured.

In an example, the frame structure is semi-statically and periodically configured.

It should be noted that when the apparatus provided by the above examples realizes its functions, merely the division of all the above functional modules is used as an example for illustration. In practical application, the above functions may be allocated to be completed by the different functional modules according to actual needs. That is, an internal structure of the device is divided into the different functional modules to complete all or part of the functions described above. In addition, the apparatus provided by the above example and the method example belong to the same concept, and its specific implementation process is detailed in the method example, which will not be repeated here.

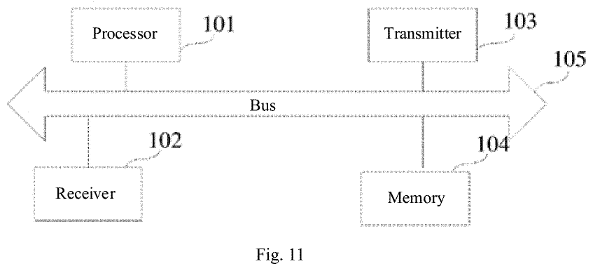

FIG. 11 shows a schematic structural diagram of a communication device (a terminal device or a network device) provided by an example of the disclosure. The communication device includes: a processor 101, a receiver 102, a transmitter 103, a memory 104, and a bus 105.

The processor 101 includes one or more processing cores, and the processor 101 executes various functional applications and information processing by running software programs and modules.

The receiver 102 and the transmitter 103 may be implemented as one communication component, which may be a communication chip.

The memory 104 is connected with the processor 101 through the bus 105.

The memory 104 may be configured to store at least one instruction, and the processor 101 is configured to execute the at least one instruction, so as to implement various steps in the above method examples.

Additionally, the memory 104 may be implemented by any type of volatile or nonvolatile storage devices or their combinations, and the volatile or nonvolatile storage devices include but are not limited to: a magnetic disk or an optical disk, an electrically erasable programmable read only memory (EEPROM), an erasable programmable read only memory (EPROM), a static random access memory (SRAM), a read only memory (ROM), a magnetic memory, a flash memory, and a programmable read-only memory (PROM).

In an example, a non-transitory computer readable storage medium is further provided. The non-transitory computer readable storage medium stores at least one instruction, at least one program, a code set or an instruction set. The at least one instruction, the at least one program, the code set or the instruction set is loaded and executed by a processor to implement the positioning and ranging method executed by a communication device and provided by each of the above method examples.

In an example, a computer program product is further provided, and configured to cause, being executed on a device including a processor and a memory, the device to execute the method as described in the above aspects. The computer program product may be included in or provided on a tangible and non-transient computer readable medium.

In an example, a chip is further provided, including a programmable logic circuit and/or program instruction, where the chip, in response to being running, is used for implementing the positioning and ranging method as described in the above aspects.

Additional non-limiting embodiments of the disclosure include the following:

1. A positioning and ranging method, applied to a network device, and including:

sending a configuration of a frame structure to a terminal device, the frame structure comprising a first time unit, and the first time unit being used for positioning and/or ranging;

a working frequency of the frame structure belongs to a frequency band not less than 6 GHz.

2. The method according to embodiment 1, the first time unit occupies t consecutive time units in a time domain, and t is a positive integer.

3. The method according to embodiment 1, the first time unit occupies m consecutive frequency units in a frequency domain, and m is a positive integer.

4. The method according to any one of embodiments 1 to 3, the first time unit occurs within the frame structure according to a period.

5. The method according to embodiment 4, further including:

determining the period according to a service load situation corresponding to the working frequency of the frame structure.

6. The method according to any one of embodiments 1 to 5, the working frequency of the frame structure belongs to at least one of a terahertz frequency band or a millimeter wave frequency band; and

the terahertz frequency band includes a frequency band between 300 GHz and 1000 GHz, and the millimeter wave frequency band includes a frequency band between 26.5 GHz and 300 GHz.

7. The method according to any one of embodiments 1 to 5, further including:

sending the configuration of the frame structure to other terminal devices except the terminal device;

a sidelink is established between the terminal device and other terminal devices.

8. The method according to any one of embodiments 1 to 5, a bandwidth corresponding to the first time unit is positively correlated with a frequency of the first time unit.

9. The method according to any one of embodiments 1 to 5, a bandwidth corresponding to the first time unit is not greater than 500 megabytes.

10. A positioning and ranging method, applied to a terminal device, and including:

obtaining a configuration of a frame structure, the frame structure comprising a first time unit, and the first time unit being used for positioning and/or ranging; and

performing positioning and/or ranging on the first time unit;

a working frequency of the frame structure belongs to a frequency band not less than 6 GHz.

11. The method according to embodiment 10, the first time unit occupies t consecutive time units in a time domain, and t is a positive integer.

12. The method according to embodiment 10, the first time unit occupies m consecutive frequency units in a frequency domain, and m is a positive integer.

13. The method according to any one of embodiments 10 to 12, the first time unit occurs within the frame structure according to a period.

14. The method according to embodiment 13, the period is related to a service load situation corresponding to the working frequency of the frame structure.

15. The method according to any one of embodiments 10 to 14, the working frequency of the frame structure belongs to at least one of a terahertz frequency band and a millimeter wave frequency band; and

the terahertz frequency band includes a frequency band between 300 GHz and 1000 GHz, and the millimeter wave frequency band includes a frequency band between 26.5 GHz and 300 GHz.

16. The method according to any one of embodiments 10 to 14, a bandwidth corresponding to the first time unit is positively correlated with a frequency of the first time unit.

17. The method according to any one of embodiments 10 to 14, a bandwidth corresponding to the first time unit is not greater than 500 megabytes.

18. The method according to any one of embodiments 10 to 14, obtaining the configuration of the frame structure includes:

receiving configuration information from a network device; and

obtaining the configuration of the frame structure according to the configuration information.

19. The method according to any one of embodiments 10 to 14, the frame structure is periodically configured.

20. The method according to any one of embodiments 10 to 14, the frame structure is semi-statically and periodically configured.

21. A positioning and ranging apparatus, including a sending module;

the sending module is configured to send a configuration of a frame structure to a terminal device, the frame structure includes a first time unit, and the first time unit is used for positioning and/or ranging; and

a working frequency of the frame structure belongs to a frequency band not less than 6 GHz.

22. The apparatus according to embodiment 21, the first time unit occupies t consecutive time units in a time domain, and t is a positive integer.

23. The apparatus according to embodiment 21, the first time unit occupies m consecutive frequency units in a frequency domain, and m is a positive integer.

24. The apparatus according to any one of embodiments 21 to 23, the first time unit occurs within the frame structure according to a period.

25. The apparatus according to embodiment 24, further including a determining module;

the determining module is configured to determine the period according to a service load situation corresponding to the working frequency of the frame structure.

26. The apparatus according to any one of embodiments 21 to 25, the working frequency of the frame structure belongs to at least one of a terahertz frequency band or a millimeter wave frequency band; and

the terahertz frequency band includes a frequency band between 300 GHz and 1000 GHz, and the millimeter wave frequency band includes a frequency band between 26.5 GHz and 300 GHz.

27. The apparatus according to any one of embodiments 21 to 25, the sending module is configured to send the configuration of the frame structure to other terminal devices except the terminal device;

a sidelink is established between the terminal device and other terminal devices.

28. The apparatus according to any one of embodiments 21 to 25, a bandwidth corresponding to the first time unit is positively correlated with a frequency of the first time unit.

29. The apparatus according to any one of embodiments 21 to 25, a bandwidth corresponding to the first time unit is not greater than 500 megabytes.

30. A positioning and ranging apparatus, applied to a terminal device, and including an obtaining module and a positioning and ranging module;

the obtaining module is configured to obtain a configuration of a frame structure, the frame structure includes a first time unit, and the first time unit is used for positioning and/or ranging; and

the positioning and ranging module is configured to perform positioning and/or ranging on the first time unit;

a working frequency of the frame structure belongs to a frequency band not less than 6 GHz.

31. The apparatus according to embodiment 30, the first time unit occupies t consecutive time units in a time domain, and t is a positive integer.

32. The apparatus according to embodiment 30, the first time unit occupies m consecutive frequency units in a frequency domain, and m is a positive integer.

33. The apparatus according to any one of embodiments 30 to 32, the first time unit occurs within the frame structure according to a period.

34. The apparatus according to embodiment 33, the period is related to a service load situation corresponding to the working frequency of the frame structure.

35. The apparatus according to any one of embodiments 30 to 34, the working frequency of the frame structure belongs to at least one of a terahertz frequency band or a millimeter wave frequency band; and

the terahertz frequency band includes a frequency band between 300 GHz and 1000 GHz, and the millimeter wave frequency band includes a frequency band between 26.5 GHz and 300 GHz.

36. The apparatus according to any one of embodiments 30 to 34, a bandwidth corresponding to the first time unit is positively correlated with a frequency of the first time unit.

37. The apparatus according to any one of embodiments 30 to 34, a bandwidth corresponding to the first time unit is not greater than 500 megabytes.

38. The apparatus according to any one of embodiments 30 to 34, the obtaining module is configured to receive configuration information from a network device; and

the obtaining module is configured to obtain the configuration of the frame structure according to the configuration information.

39. The apparatus according to any one of embodiments 30 to 34, the frame structure is periodically configured.

40. The apparatus according to any one of embodiments 30 to 34, the frame structure is semi-statically and periodically configured.

41. A network device, including:

a processor;

a transceiver connected with the processor; and

a memory for storing an executable instruction of the processor;

the processor is configured to load and execute the executable instruction to implement the positioning and ranging method according to any one of embodiments 1 to 9.

42. A terminal device, including:

a processor;

a transceiver connected with the processor; and

a memory for storing an executable instruction of the processor;

the processor is configured to load and execute the executable instruction so as to implement the positioning and ranging method according to any one of embodiments 10 to 20.

43. A non-transitory computer readable storage medium, and the non-transitory readable storage medium stores an executable instruction, and the executable instruction is loaded and executed by a processor, so as to implement the positioning and ranging method according to any one of embodiments 1 to 20.

Those skilled in the art can understand that implementation of all or part of the steps of the above examples can be completed by hardware, or can be completed by instructing relevant hardware through programs. The programs can be stored in a computer readable storage medium. The storage medium mentioned above can be a read only memory, a disk, or an optical disk and the like.

The above is merely an optional example of the disclosure and is not intended to limit the disclosure. Any modification, equivalent substitution, improvement and the like made within the spirit and principle of the disclosure shall all be contained in the protection scope of the disclosure.

1. A positioning and ranging method, comprising:
sending, by a network device, a configuration of a frame structure to a terminal device, the frame structure comprising a first time unit, and the first time unit being configured for positioning or ranging; wherein
a working frequency of the frame structure belongs to a frequency band not less than 6 GHz.

2. The method according to claim 1, wherein
the first time unit occupies t consecutive time units in a time domain, and t is a positive integer.

3. The method according to claim 1, wherein
the first time unit occupies m consecutive frequency units in a frequency domain, and m is a positive integer.

4. The method according to claim 1, wherein the first time unit occurs within the frame structure according to a period; and
wherein the method further comprises:
determining the period according to a service load situation corresponding to the working frequency of the frame structure.

5. (canceled)

6. The method according to claim 1, wherein
the working frequency of the frame structure belongs to at least one of a terahertz frequency band or a millimeter wave frequency band; and
the terahertz frequency band comprises a frequency band between 300 GHz and 1000 GHz, and the millimeter wave frequency band comprises a frequency band between 26.5 GHz and 300 GHz.

7. The method according to claim 1, further comprising:
sending the configuration of the frame structure to other terminal devices except the terminal device, wherein
a sidelink is established between the terminal device and other terminal devices.

8. The method according to claim 1, wherein
a bandwidth corresponding to the first time unit is positively correlated with a frequency of the first time unit.

9. The method according to claim 1, wherein
a bandwidth corresponding to the first time unit is not greater than 500 megabytes.

10. A positioning and ranging method, applied to a terminal device, and comprising:
obtaining, by a terminal device, a configuration of a frame structure, the frame structure comprising a first time unit, and the first time unit being configured for positioning and/or ranging; and
performing, by the terminal device, positioning and/or ranging on the first time unit, wherein a working frequency of the frame structure belongs to a frequency band not less than 6 GHz.

11. The method according to claim 10, wherein
the first time unit occupies t consecutive time units in a time domain, and t is a positive integer.

12. The method according to claim 10, wherein
the first time unit occupies m consecutive frequency units in a frequency domain, and m is a positive integer.

13. The method according to claim 10, wherein
the first time unit occurs within the frame structure according to a period, and the period is related to a service load situation corresponding to the working frequency of the frame structure.

14. (canceled)

15. The method according to claim 10, wherein
the working frequency of the frame structure belongs to at least one of a terahertz frequency band and a millimeter wave frequency band; and
the terahertz frequency band comprises a frequency band between 300 GHz and 1000 GHz, and the millimeter wave frequency band comprises a frequency band between 26.5 GHz and 300 GHz.

16. The method according to claim 10, wherein
a bandwidth corresponding to the first time unit is positively correlated with a frequency of the first time unit.

17. The method according to claim 10, wherein
a bandwidth corresponding to the first time unit is not greater than 500 megabytes.

18. The method according to claim 10, wherein
obtaining the configuration of the frame structure comprises:
receiving configuration information from a network device; and
obtaining the configuration of the frame structure according to the configuration information.

19. The method according to claim 10, wherein
the frame structure is periodically configured, or the frame structure is semi-statically and periodically configured.

20-40. (canceled)

41. A network device, comprising:
a processor;
a transceiver connected with the processor; and
a memory for storing an executable instruction of the processor, wherein
the processor is configured to load and execute the executable instruction to send a configuration of a frame structure to a terminal device, the frame structure comprising a first time unit, and the first time unit being configured for positioning or ranging; wherein a working frequency of the frame structure belongs to a frequency band not less than 6 GHz.

42. A terminal device, comprising:
a processor;
a transceiver connected with the processor; and
a memory for storing an executable instruction of the processor, wherein
the processor is configured to load and execute the executable instruction so as to implement the positioning and ranging method according to claim 10.

43. A non-transitory computer readable storage medium, wherein the readable storage medium stores an executable instruction, and the executable instruction is loaded and executed by a processor, so as to implement the positioning and ranging method according to claim 1.
